(19) United States
(12) Patent Application Publication
(10) Pub. No.: US 2016/0099643 A1
(43) Pub. Date: Apr. 7, 2016

(54) Configurable Power Supply Circuit with External Resistance Detection

(71) Applicant: Texas Instruments Incorporated, Dallas, TX (US)

(72) Inventor: Faruk Jose Nome Silva, Sunnyvale, CA (US)

(73) Assignee: TEXAS INSTRUMENTS INCORPORATED, Dallas, TX (US)

(21) Appl. No.: 14/863,014

(22) Filed: Sep. 23, 2015

Related U.S. Application Data
(60) Provisional application No. 62/060,444, filed on Oct. 6, 2014.

(51) Int. Cl. H02M 3/158

(52) U.S. Cl. CPC H02M 3/158

(57) ABSTRACT

A power supply circuit, suitable for use in an integrated circuit, the circuit configured to detect whether an output voltage has been specified using an external resistance network. The power supply circuit is configured to determine the appropriate output voltage to be generated based on a voltage measured at a single input pin of the power supply circuit, where the single input pin provides a feedback voltage used in the control loop of the power supply circuit. Based on the feedback voltage at the input pin, the power supply circuit is configured to detect the presence of a resistance network external to the single input pin. If an external resistance network is detected, the power supply is configured to generate the output voltage specified at the input pin. If no external resistance network is detected, the power supply is configured to generate a default output voltage.

### CROSS-REFERENCE TO RELATED APPLICATIONS

The present application claims the benefit of the filing date of Provisional Application No. 62/060,444, filed Oct. 6, 2014.

### TECHNICAL FIELD

The recited claims are directed, in general, to regulated power supplies and, more specifically, to the configuration of power output by a regulated power supply.

### BACKGROUND

Electronic devices rely on power supply components to provide a regulated amount of power in accordance with the requirements and limitations of the electronic device. Power supplies typically receive an input power supply and are configured to output a regulated supply of power. In many cases, a power supply converts a high-voltage input, such as mains power, to a regulated, low-voltage output suitable for powering electronic devices. In other cases, a power supply converts battery power to a regulated voltage. The output voltage that is generated by a power supply is determined based on the specifications of the electronic device to be powered.

Many electronic devices are designed to operate with regulated power supplies designed to generate only the specific, fixed output voltage used by the device. Based on the voltage that is required by an electronic device, a conventional fixed-voltage power supply is selected that has been designed to output this particular required voltage. If a different voltage is required, a different fixed-voltage power supply is selected that is capable of supplying the required voltage. This use of different fixed-voltage power supply designs that are customized to generate different specific output voltages, requires a power supply manufacturer to support a large number of power supply models. This also requires electronic device manufacturers to qualify each different power supply model in order to incorporate it into their designs.

Rather than provide a different power supply component for every supported fixed output voltage, it is desirable in certain circumstances to utilize an adjustable power supply that can be configured to support a range of output voltages. Adjustable voltage outputs by a power supply may be supported via an input pin of the power supply, whereby the output voltage is set based on the voltage detected at the input pin. In this manner, an adjustable power supply can be configured support multiple different output voltages.

Conventional adjustable output and conventional fixed output power supplies are not interchangeable. A device designed to work with a fixed output power supply does not include the circuitry required to specify an adjusted output voltage. It is preferable to use a single power supply that is capable of supporting devices designed to operate with both fixed and adjustable output voltages.

Conventional power supplies that are capable of supporting both fixed and adjustable output devices do so by providing at least two input pins to the power supply. One pin may specify a feedback voltage for use in the control loop of power supply and another pin may specify if a fixed output voltage is to be provided by the power supply. For power supply manufacturers, it is further preferable to utilize a single power supply capable of operating with both fixed and adjustable output devices while only having to provide one pin as an input to the power supply.

### SUMMARY OF THE INVENTION

According to various aspects of the application, a power supply circuit is recited whereby the output voltage of the power supply is configured based on a control loop feedback voltage provided at an input pin to the power supply circuit. Based on the input pin voltage, the power supply is configured to detect whether a resistance network is present external to the input pin. The power supply is configured to detect the presence of external resistance network by alternating between attempts to pull the feedback voltage to a high level and to low level. Based on the response to the pull-up and pull-down attempts at the input pin voltage, the power supply determines if an external resistance network is present in the control loop. If an external resistance network is detected, the power supply is configured to generate the output voltage specified by the resistance network at the input pin. If no external resistance network is detected, the power supply is configure to generate a default output voltage. In this manner, the power supply can be configured to generate various output voltages using a single input pin.

According to one aspect of the application, a power supply circuit and a method for configuring the output voltage of a power supply are provided, the power supply comprising: a regulator operable to convert an input voltage to an output voltage and further operable to set the output voltage based on a feedback voltage provided via a feedback loop; an input pin operable to receive an input pin voltage; and a detection circuit operable to set the feedback voltage based on the detection of a resistance connected external to the input pin, wherein the resistance is detected based on the input pin voltage.

According to additional aspects of the application, the detection circuit may be further operable to set the feedback voltage to a default output voltage, if no external resistance is detected. The detection circuit may be further operable to set the feedback voltage to the input pin voltage, if an external resistance is detected. The detection circuit may be further operable to set the feedback voltage to a reference voltage of the power supply, if an external resistance is detected and the input pin voltage has a pre-defined value. The detection circuit may include an internal resistance network specifying the default output voltage and wherein the feedback voltage is set to the default output voltage by connecting the internal resistance network to the feedback loop. The detection circuit may be enabled during a test mode that expires after a predefined interval.

According to additional aspects of the application, the detection circuit may further comprise: a pull-up circuit operable to apply a first pulse in the output current of the power supply and further configured to detect a first change in the input pin voltage in response to the first pulse; and a pull-up latch operable to record whether the first change is detected in the input pin voltage. According to additional aspects of the application, the detection circuit may further comprise: a pull-down circuit operable to apply a second pulse in the output current of the power supply and further configured to detect a second change in the input pin voltage in response to the second pulse; and a pull-down latch operable to record whether the second change is detected in the input pin voltage. An external resistance may be determined to be connected to the input pin if the pull-up latch records the detection of the first change in the input pin voltage and the pull-down latch records the detection of the second change in the input pin voltage. The duration of the first pulse may be selected based on a capacitance connected external to the input pin

### BRIEF DESCRIPTION OF THE DRAWINGS

Having thus described the invention in general terms, reference will now be made to the accompanying drawings, wherein:

FIG. 1 is a schematic diagram depicting certain components of a conventional adjustable power supply that is configured using a voltage divider.

FIG. 2 is a schematic diagram of certain components of a power supply according to one aspect of the application, the power supply including a default detection circuit for detection of an external resistance network.

FIG. 3 is a schematic diagram of certain components of a power supply, according to another aspect of the application, the power supply having detected no external resistance network and generating a default output voltage.

FIG. 4 is a schematic diagram of certain components of a power supply, according to another aspect of the application, the power supply having detected an external resistance network specifying an output voltage.

FIG. 5 is a schematic diagram of certain components of a power supply, according to another aspect of the application, the power supply having detected an external resistor specifying the use of the power supply reference voltage.

FIG. 6 is a schematic diagram of a detection component configured to determine whether an external resistance is present in the feedback control loop.

### DETAILED DESCRIPTION

The invention now will be described more fully hereinafter with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. One skilled in the art may be able to use the various embodiments of the invention.

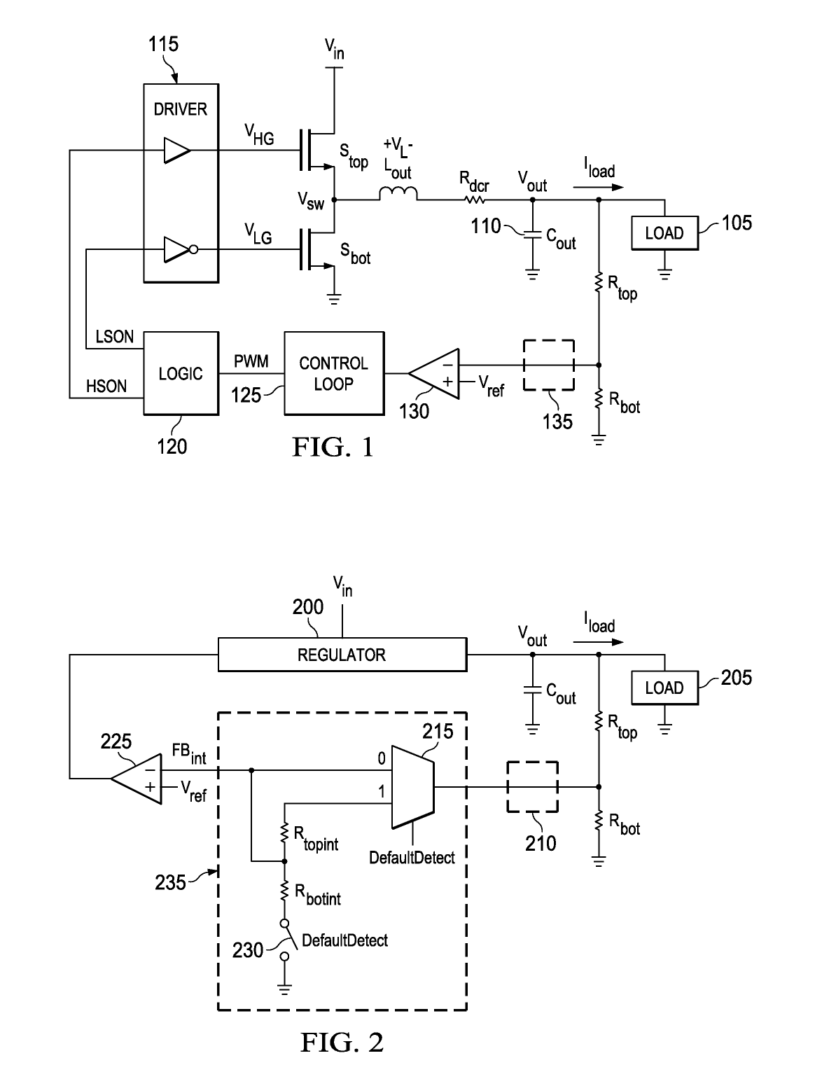

FIG. 1 depicts a certain components of conventional adjustable switched mode power supply (SMPS) that receives an input voltage, V_{IN}, and generates a regulated output voltage, V_{OUT}, to a load 105. The conventional power supply of FIG. 1 utilizes a voltage divider to specify the output voltage, V_{OUT}, required by load 105. The output voltage, V_{OUT}, is also provided as an input to the power supply via an input pin 135, thus creating a feedback loop used by the power supply to regulate the output voltage, V_{OUT}. The output voltage provided to input pin 135 is determined based on the voltage requirements of load 105 and is set using a voltage divider comprised of R_{TOP} and R_{BOT}.

The voltage provided to the input pin 135 is then provided to a comparator component 130 that is configured to provide feedback voltage to the control loop of the power supply. As another input, the comparator component 130 receives a reference voltage, V_{REF}, that is the lowest regulated voltage that is supported by the power supply. A typical reference voltage is 1V. The comparator component 130 is configured to output either the voltage received from the input pin 135 or the reference voltage, V_{REF}, as a feedback voltage depending on which input is greater. This ensures that the power supply will not generate an output voltage that is lower than the reference voltage, V_{REF}.

The conventional power supply of FIG. 1 is a switched mode power supply that implements using a buck regulator using control loop 125 to generate a pulse-width modulated (PWM) signal. The PWM signal is used by switching logic 120 to generate alternating low-side and high-side signals. These alternating signals are used by a driver 115 to generate gate signals that control switching elements to convert the input voltage, V_{IN}, to a lower voltage signal that is smoothed to generate an output voltage, V_{OUT}, suitable for powering the load 105.

The output voltage, V_{OUT}, generated by the adjustable power supply is determined based on the output of the network of resistors used as the input the feedback loop. In the conventional power supply of FIG. 1, the output voltage, V_{OUT}, is specified using a voltage divider implemented by series resistors R_{TOP} and R_{BOT}. Configured in this manner, the output voltage of the power supply of FIG. 1 is provided by:

$$Vout = Vref * ( 1 + \frac{Rtop}{Rbot} )$$

As provided above, certain electronic devices are configured to operate with power supplies that are designed to generate only the specific, fixed output voltage that is required by the device. Conventional adjustable output and conventional fixed output power supplies are not interchangeable, however. For example, if a device designed to operate with a fixed voltage power supply (and thus not including a R_{TOP} and R_{BOT} resistor network) is connected to the conventional adjustable power supply illustrated in FIG. 1, the power supply will only generate a reference voltage output. The conventional adjustable power supply requires the device to specify any output voltage other than the reference voltage.

The only fixed voltage that can be supported using the conventional, adjustable power supply of FIG. 1 is the reference voltage, V_{REF}. However, the reference voltage, V_{REF}, is the lowest regulated voltage that is supported by the power supply. This reference voltage is not a commonly used output voltage. As such, the conventional, adjustable power supply of FIG. 1 is not suitable for use as a fixed-voltage power supply without the power supply providing two input pins. One input pin to detect an adjustable voltage signal and a second pin to detect a fixed voltage signal. There is a need for an adjustable power supply that can be used in both fixed and adjustable voltage designs while only requiring one pin be provided as in input by the power supplier.

FIG. 2 depicts a circuit diagram of certain components of a switched mode power supply that illustrates certain aspects of the present application. In the power supply of FIG. 2, a switching regulator 200 is used to convert an input voltage, V_{IN}, to a lower output voltage, V_{OUT}, suitable for powering load 205. The power supply is configured to provide load 205 with either a default, fixed output voltage or an output voltage adjusted to a voltage specified by the device. The power supply generates a fixed, default output voltage if it is determined that no output voltage adjustments have been specified by the device, indicating that the load 205 is configured to operate using the default output voltage of the power supply. The power supply determines whether to generate the default, fixed output voltage or the requested adjusted output voltage based on the input to a single input pin 210 of the power supply.

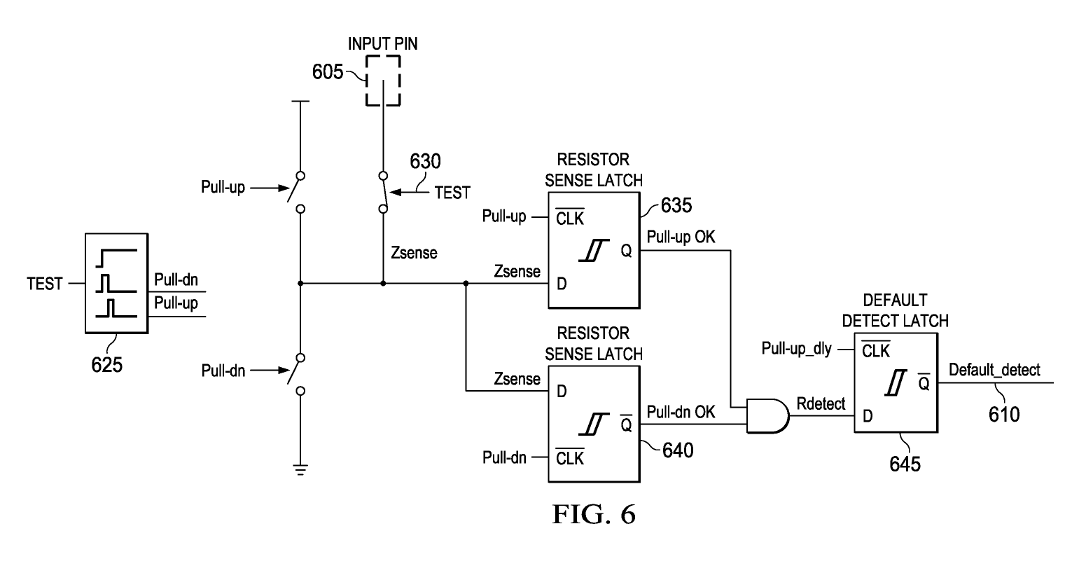

The power supply of FIG. 2 includes a default detection circuit 235 that determines whether an adjusted output voltage or the default output voltage has been specified for use by the load 205. If an adjusted output voltage is specified, a resistor network external to the default detection circuit 235 is present in the feedback control loop. The external resistor network is configured to adjust the voltage at the input pin 210 of the power supply. If no external resistor network is present, this indicates that the device is designed to operate with a fixed output voltage, in which case the power supply outputs the default output voltage. The default detection circuit 235 senses whether an external resistor network is present in order to determine whether to output an adjusted output voltage specified by the device or the default output voltage. The default detection circuity 235 utilizes a detection component 215 that implements a testing procedure to sense whether an external resistance network is connected to the input pin 210. The details of the detection component 215 are provided below with respect to FIG. 6.

In the power supply of FIG. 2, a resistor network external to the default detection circuit 235 is present in the form of the voltage divider implemented using R_{TOP} and R_{BOT}. The voltage divider formed by R_{TOP} and R_{BOT} is connected as an input to the power supply input pin 210. If no external resistor network, such as the R_{TOP} and R_{BOT} voltage divider, is detected by the detection component 215, the default detection circuit 235 utilizes an internal network of resistors to set the default output voltage to be generated. In the power supply of FIG. 2, the internal resistor network is comprised of a voltage divider implemented by R_{TOPINT} and R_{BOTINT}. If no external resistance network is detected, the detection component 215 signals the internal resistance network to generate a default output voltage.

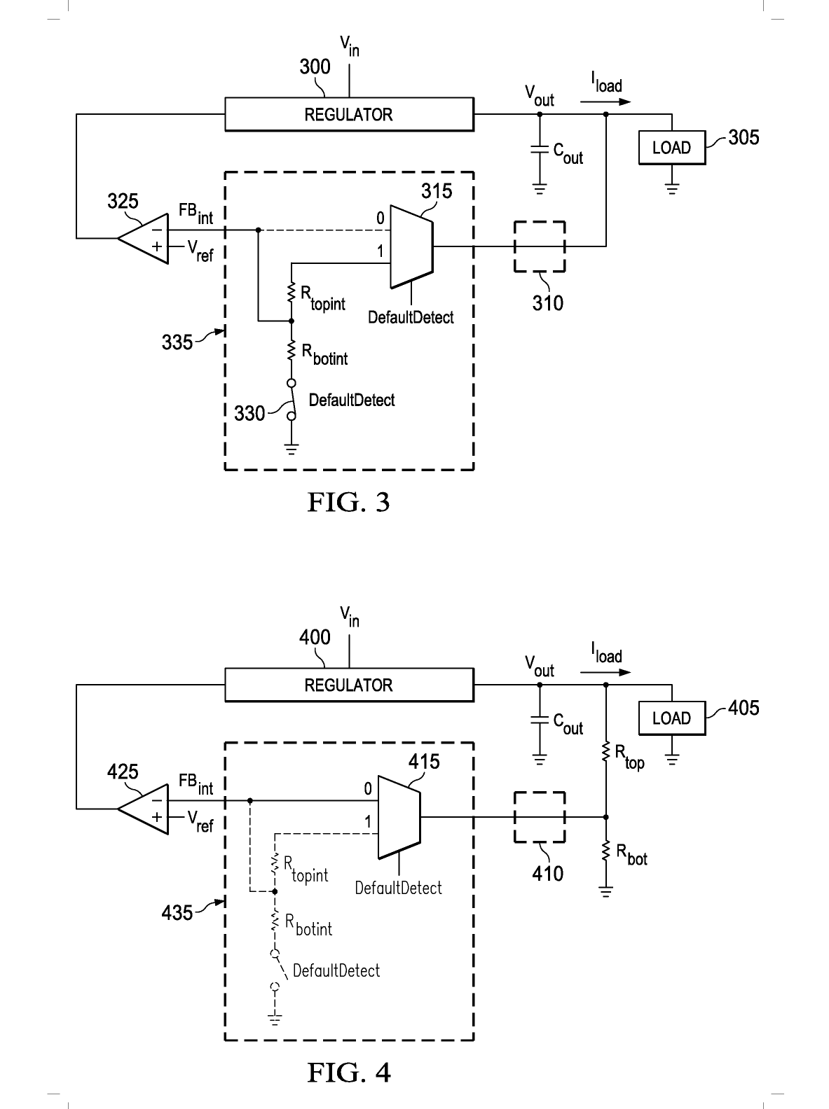

FIG. 3 illustrates a scenario, according to one aspect of the application, where a switching regulator 300 is used to convert an input voltage, V_{IN}, to a lower output voltage, V_{OUT}, suitable for powering load 305. In the power supply of FIG. 3, no external resistor network is present and the power supply responds by generating a default output voltage. With no external resistor network present, the input pin 310 receives the output voltage, V_{OUT}, as an input. The detection component 315 of the default detection circuit 335 determines that the voltage at the input pin 310 is the output voltage, V_{OUT}. In response, the detection component 315 outputs a signal indicating that the default output voltage is to be generated by the power supply. This signal configures a switch element 330 of the default detection circuit 335 to connect the internal resistance network to the feedback control loop of the power supply. In FIG. 3, the internal resistance network is comprised of a voltage divider implemented by R_{TOPINT} and R_{BOTINT}.The comparator component 325 determines that the default output voltage generated by the internal resistor network is greater than the reference voltage and outputs the default voltage to the feedback control loop of the power supply. Configured in this manner, the power supply generates a default output voltage specified by:

$$Vout = Vref * ( 1 + \frac{Rtopint}{Rbotint} )$$

FIG. 4 illustrates a scenario, according to one aspect of the application, where a switching regulator 400 is used to convert an input voltage, V_{IN}, to a lower output voltage, V_{OUT}, suitable for powering load 405. In the power supply of FIG. 4, an external resistor network is provided by the device and the power supply responds by generating the adjusted output voltage specified by the external resistor network. The adjusted output voltage is specified in FIG. 4 by a voltage divider implemented by R_{TOP} and R_{BOT}. This adjusted output voltage is provided to the power supply via input pin 410. This input is processed by the detection component 415 of the default detection circuit 435. The detection component 415 determines that an external resistance is connected to input pin 410 such that power supply is to generate the adjusted output voltage specified at the input pin 410 by the voltage divider.

Upon detection of the external resistance, the adjusted output voltage from pin 410 is outputted by the detection component 415 to comparator component 425. Upon verification that the adjusted output voltage is greater than the reference voltage of the power supply, the comparator component 425 outputs the adjusted voltage, thus configuring the feedback loop of the power supply. Since an adjusted output voltage has been specified instead of the default output voltage of the power supply, the detection component 415 does not enable the internal resistance network component of the default detection circuit 435. Instead, the detection component 415 connects the external resistance network, comprised of the voltage divider implemented by R_{TOP} and R_{BOT}, to the feedback control loop of the power supply.

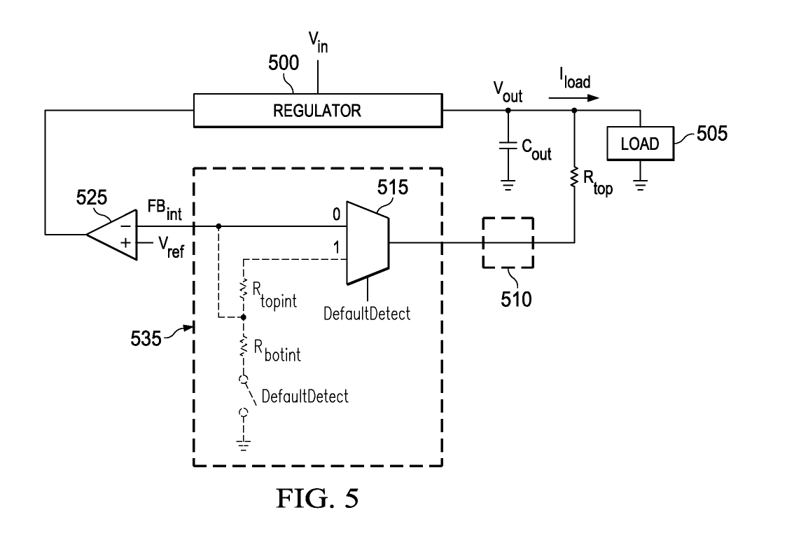

FIG. 5 illustrates another aspect of the application, by which the power supply is configured to output the advertised reference voltage of the power supply. Like the power supplies of the prior figures, the power supply of FIG. 5 utilizes a switching regulator 500 to convert an input voltage, V_{IN}, to a lower output voltage, V_{OUT}, suitable for powering load 505. In the power supply of FIG. 5, the network of resistors is comprised of a single resistor R_{TOP}, where the resistance of R_{TOP} is selected to direct the default detection circuit 535 to set the output voltage to the reference voltage of the power supply. In certain aspects of the application, R_{TOP} is a mode-select resistor that has been agreed upon as directing the power supply to output its advertised reference voltage as an output.

As with the voltage divider resistance network of FIG. 3, the detection component 515 measures the voltage at the input pin 510 and determines that a resistance is present in the feedback control loop. In FIG. 5, the voltage drop at the input pin created by R_{TOP} is recognized by the detection component 515 as signaling the use of the reference voltage by the electronic device. When the specific voltage associated with R_{TOP} is detected at the input pin 510, the detection component 515 outputs a default detect signal that disconnects the internal resistance network from the feedback control loop. The detection component 515 outputs the reference voltage which is recognized by the comparator component 525 as an indication to connect the reference voltage to the feedback control loop. In certain aspects of the application, R_{TOP} may be selected to generate the reference voltage at the input pin 510.

FIG. 6 illustrates an implementation of a detection component that operates in accordance with the above descriptions of this component. The detection component receives the feedback voltage provided by the electronic device at the input pin 605. Based on this input pin voltage, the detection component determines whether an external resistance network is present in the feedback control loop, indicating that the electronic device has been configured to specify an output voltage to be generated by the power supply. As described, in certain aspects of the application, the presence of particular external resistance in the feedback control loop indicates that the electronic device requires the reference voltage of the power supply. If no external resistance is detected (indicating an electronic device that is configured to operate with a fixed-output power supply), the detection component generates an output 610 signaling the generation of a default output voltage by the power supply.

The detection component utilizes pull-up and pull-down logic to determine whether the input pin voltage 605 has been adjusted using an external resistance network or whether the input pin voltage 605 is the output voltage of the power supply. In certain aspects of the application, a test mode is initiated during which the detection component tests the input pin voltage 605 to determine if a resistance network is present. A test mode is initiated via a test signal 630 that connects the pull-up and pull-down logic to the input pin voltage 605, thus activating the pull-up and pull-down logic.

Test mode may be utilized during initialization of the power supply. In many aspects of the application, test mode during initialization is sufficient. Other aspects of the application, post-start up test modes can be initiated. The initiation of the test mode serves results in the commencement of a timer. Once the timer expires, the test signal 630 disconnects the pull-up and pull-down logic from the feedback control loop and the test mode ends. By enabling the pull-up and pull-down logic only during test mode allows power to be conserved and avoids floating gate issues.

Once the test mode has been initiated and the detection component is configured for testing of the input pin voltage 605, two consecutive pulses 625 are generated, one pulse used to pull up the input pin voltage and another pulse used to pull down the input pin voltage. The detection component utilizes resistor sense latches 635, 640 to determine whether the pull-up and pull-down attempts were successful. Upon being activated, each resistor sense latch 635,640 measures the response to a pulse at the input pin voltage 605 and compares the response against a reference signal.

Resistor sense latch 635 determines if the pull-up was successful by measuring the input pin voltage 605 and comparing it against a reference signal that specifies an expected increase in voltage may expected due the presence of a resistance network in the feedback loop. During a pull-up attempt, the pull-up logic increases the current in the power supply output to determine whether the input pin voltage 605 is affected. If the resistor sense latch 635 determines the input pin voltage 605 has been pulled up as expected, with respect to the reference signal, the latch records a value indicating the pull-up attempt was successful.

If resistor latch 635 determines that pull-up was successful, this indicates that an external resistance network is present in the feedback loop. If no external resistance network is present, the detection component will be unable to pull-up the input pin voltage during the time allotted to a pull-up pulse. With reference to FIG. 3, where no external resistance network is present, a pulse in the current will be absorbed in charging C_{OUT} and will not result in an increase in the input pin voltage until C_{OUT} is fully charged. As C_{OUT} is typically a relatively large capacitor, C_{OUT} will not fully charge during a testing cycle and thus prevent a pull-up attempt from succeeding. If any external resistance network is present in parallel with C_{OUT}, as in FIG. 4, for instance, the detection component will be able to establish an increase in the input pin voltage in response to a pulse in the output voltage.

Resistor latch 640 records the input pin voltage 605 and determines if the pull-down was successful. Like the pull-up attempt, if no external resistance network is present, the detection component will be unable to pull-down the input pin voltage during the time allotted to a pull-down pulse. The use of pull-down logic allows the detection component to test the ability to affect the input pin voltage in situations where the output voltage is relatively high. As before, if no external resistance network is present, the change in the output current of the power supply in a pull-down pulse will be masked by C_{OUT} and will preclude a response in the input pin voltage during the testing cycle.

In certain aspects of the application, timers are used to specify the length of pull-down and pull-up test cycles. Upon activation of the test mode, a pull-up timer is activated. As described, the detection component determines whether there is an expected increase in the input pin voltage in response to a pulse in the output current of the power supply. Prior to the expiration of the pull-up timer, the resistor sense latch 635 samples its inputs and records whether the pull-up attempt was successful. Conversely, a pull-down timer specifies the duration of a pull-down attempt and is used to trigger the resistor sense latch 640 sampling its inputs and recording whether the pull-down attempt was successful.

In certain aspects of the application, the length of test cycled during which pull-up and pull-down attempts are made are configured based on capacitors present in the feedback control loop. For instance, certain regulators include a feedforward capacitor, C_{FF}, for using in improving the transient response of V_{OUT}. A feedforward capacitor is typically connected in parallel to R_{TOP} and is coupled to C_{OUT}. In order to account for the feedforward capacitor in the feedback loop, the duration of the pull-up and pull-down pulses used in a test cycle may be specified by:

T_{PULL}>3*R_{PULL}*C_{FF}

where T_{PULL} is the length of the pull-up and pull-down pulses, R_{PULL} is the pull-up and pull-down resistance and C_{FF} is the feedforward capacitance.

After a successive pull-up and pull-down attempts have been completed such that the input pin voltage 605 has been recorded by the resistor latches 635, 640, the detection component determines the correct voltage for the power supply output to the electronic device. If the pull-down logic determines that the pull-down was successful and the pull-up logic determines that the pull-up was successful, this indicates that a resistance network is connected in the feedback control loop. The signals from each of the resistor latches 635, 640 indicating whether the pull-up and pull-down attempts were successful are inputs to an AND gate. The output from the AND gate is stored in default detection latch 645. If the recorded state held by default detection latch 345 indicates that a resistance network is present, the default detected signal 610 is deasserted and the internal resistance network of the default detection circuit is not connected to the feedback loop. The input pin voltage 605 thus indicates the adjusted output voltage specified for use by the electronic device and is connected to the feedback control loop and used to specify the output voltage of the power supply.

If either the pull-down attempt or the pull-up attempt fail, this indicates that no resistance network is present in the control loop as the input pin voltage is determined to be the output voltage of the power supply. In this scenario, the inputs to the AND gate from each of the resistor latches 635, 640 results in a low output by the AND gate. This output is stored by the default detection latch 645, which asserts the default detected signal 610 to signal the connection of the internal resistance network to the feedback loop. The input pin voltage 605 thus indicates that the default output voltage, specified by the internal resistance network, is to be generated by the power supply.

In the aspects of the application described above, the power supply is a voltage regulator, such as a buck converter, that serves as a DC-DC convertor. Other applications may include low-drop out regulators, short-circuit detection components, and software pin detection components.

Many modifications and other embodiments of the invention will come to mind to one skilled in the art to which this invention pertains having the benefit of the teachings presented in the foregoing descriptions, and the associated drawings. Therefore, it is to be understood that the invention is not to be limited to the specific embodiments disclosed. Although specific terms are employed herein, they are used in a generic and descriptive sense only and not for purposes of limitation.

What is claimed is:

1. A power supply circuit comprising:
a regulator operable to convert an input voltage to an output voltage and further operable to set the output voltage based on a feedback voltage provided via a feedback loop;
an input pin operable to receive an input pin voltage; and
a detection circuit operable to set the feedback voltage based on the detection of a resistance connected external to the input pin, wherein the resistance is detected based on the input pin voltage.

2. The power supply circuit of claim 1, wherein the detection circuit is further operable to set the feedback voltage to a default output voltage, if no external resistance is detected.

3. The power supply circuit of claim 1, wherein the detection circuit is further operable to set the feedback voltage to the input pin voltage, if an external resistance is detected.

4. The power supply circuit of claim 1, wherein the detection circuit is further operable to set the feedback voltage to a reference voltage of the power supply, if an external resistance is detected and the input pin voltage has a pre-defined value.

5. The power supply circuit of claim 2, wherein the detection circuit includes an internal resistance network specifying the default output voltage and wherein the feedback voltage is set to the default output voltage by connecting the internal resistance network to the feedback loop.

6. The power supply circuit of claim 1, wherein the detection circuit comprises:
a pull-up circuit operable to apply a first pulse in the output current of the power supply and further configured to detect a first change in the input pin voltage in response to the first pulse; and
a pull-up latch operable to record whether the first change is detected in the input pin voltage.

6. The power supply circuit of claim 6, wherein the detection circuit further comprises:
a pull-down circuit operable to apply a second pulse in the output current of the power supply and further configured to detect a second change in the input pin voltage in response to the second pulse; and
a pull-down latch operable to record whether the second change is detected in the input pin voltage.

8. The power supply circuit of claim 7, wherein an external resistance is connected to the input pin if the pull-up latch records the detection of the first change in the input pin voltage and the pull-down latch records the detection of the second change in the input pin voltage.

9. The power supply circuit of claim 1, wherein the detection circuit is enabled during a test mode that expires after a predefined interval.

10. The power supply circuit of claim 6, wherein the duration of the first pulse is selected based on a capacitance connected external to the input pin.

11. A method for configuring the output voltage of a power supply comprising:
setting an output voltage of the power supply based on a feedback voltage provided via a feedback loop;
measuring an input pin voltage at an input pin of the power supply;
detecting a resistance connected external to the input pin, wherein the resistance is detected based on the input pin voltage; and
setting the feedback voltage based on the detection of a resistance connected external to the input pin.

12. The method of claim 11, further comprising:
setting the feedback voltage to a default output voltage, if no resistance is detected external to the input pin.

13. The method of claim 11, further comprising:
setting the feedback voltage to the input pin voltage, if a resistance is detected external to the input pin.

14. The method of claim 11, further comprising:
setting the feedback voltage to a reference voltage of the power supply, if a resistance is detected external to the input pin and the input pin voltage has a pre-defined value.

15. The method of claim 12, wherein the feedback voltage is set to the default output voltage by connecting an internal resistance network to the feedback loop.

16. The method of claim 11, further comprising:
applying a first pulse in the output current of the power supply;
detecting a first change in the input pin voltage in response to the first pulse; and
recording whether the first change is detected in the input pin voltage.

17. The method of claim 16, further comprising:
applying a second pulse in the output current of the power supply;
detecting a second change in the input pin voltage in response to the second pulse; and
recording whether the second change is detected in the input pin voltage.

18. The method of claim 7, further comprising
determining that an external resistance is connected to the input pin if the first change in the input pin voltage is recorded in response to the first pulse and the second change in the input pin voltage is recorded in response to the second pulse.

19. The method of claim 11, further comprising:
detecting the external resistance during a test mode that expires after a predefined interval.

20. The method of claim 16, wherein the duration of the first pulse is selected based on a capacitance connected external to the input pin.
